(19) United States
(12) Patent Application Publication
(10) Pub. No.: US 2019/0096536 A1
(43) Pub. Date: Mar. 28, 2019

(54) PLATE TYPE NUCLEAR MICRO REACTOR

(71) Applicant: Westinghouse Electric Company LLC, Cranberry Township, PA (US)

(72) Inventors: Yasir Arafat, Pittsburgh, PA (US); Jurie J. Van Wyk, Cranberry Township, PA (US)

(73) Assignee: Westinghouse Electric Company LLC, Cranberry Township, PA (US)

(21) Appl. No.: 16/145,933

(22) Filed: Sep. 28, 2018

Related U.S. Application Data
(60) Provisional application No. 62/564,519, filed on Sep. 28, 2017.

(51) Int. Cl. G21C 15/257; F28D 15/04; F28D 15/06; G21C 15/08; G21C 5/16; G21C 5/12

(52) U.S. Cl. CPC G21C 15/257; F28D 15/046; G21C 5/12; G21C 15/08; G21C 5/16; F28D 15/06

(57) ABSTRACT

This invention provides a nuclear reactor design that can enable automated or semi-automated manufacturing of a small reactor in a mechanized factory. This is possible by following a layered approach to combine simple “plate” geometries with the use of diffusion bonding and computer aided manufacturing techniques that integrate all the fuel, axial reflectors, axial gamma and neutron shields, fuel gas plenum, heat removal mechanism, primary heat exchangers and moderator all in one block or component. The final assembled block has no welds and limits or eliminates manual operations. This design has the potential to reduce the fabrication time of an entire nuclear reactor to just a few days.

### CROSS REFERENCE TO RELATED APPLICATION

This application is a traditional application and claims priority to U.S. Provisional Application Ser. No. 62/564,519, filed Sep. 28, 2017, entitled “Integrated Plate Type Nuclear Fuel Assembly Design—Primary Heat Exchanger Design To Enable Automated Manufacturing Of A Nuclear Micro Reactor”, the contents of which are incorporated herein.

### BACKGROUND

### 1. Field

This invention relates generally to relatively small reactors and, more particularly, to a nuclear reactor system that can enable automated or semi-automated manufacturing of a small reactor in a mechanized factory.

### 2. Related Art

One of the highest risks in today's new nuclear power plants is the on-site construction timeline and costs. Current nuclear power plants undergo construction for several years, requiring high capital investment cost. This poses significant risks to the customer and vendor. Small modular reactors have tried to reduce some of the construction risks by promoting modular construction. While this reduces the construction time and risks slightly, it still requires long supply duration and more upfront capital cost. Therefore, a way to minimize construction risk and costs is to eliminate onsite construction, i.e., fabrication, assembly, integration and commissioning of the nuclear reactor in the factory and transport it to site on a truck (or other locomotives) for on-site installation, which can be completed in a matter of days instead of years. This strategy to nearly eliminate on-site construction is possible when the complete nuclear reactor, typical <30 MWe is designed to be produced completely in the factory and within practical transport limits.

Although many have proposed factory manufacturing, the total capital investment cost (TCIC) depends on many factors such as design for manufacturability, production capacity, level of automation, factory space, etc. Although any small nuclear reactor can be made in the factory, the amount of manual labor extends the fabrication time tremendously, thus increasing lead time. In order to meet capacity, the factory has to establish parallel assembly lines which require additional capital, labor, footprint, etc, all of which increases cost. This puts significant constraint on the business model since it raises the price floor for the product in order to sustain factory operations. This eventually leads to high TCIC.

Thus, it is an object of this invention to provide a nuclear reactor system design that lends itself to automated manufacturing.

It is a further object of this invention to provide such a reactor system design that requires few pieces of equipment, a relatively small factory footprint and minimal labor to manufacture.

### SUMMARY

To achieve the foregoing objectives this invention provides a nuclear reactor system formed as an integral block in a plurality of layers. In the broadest sense, the invention comprises a first layer that includes nuclear fuel and a second layer that includes a heat transport system. The layers are configured from metal sheets that house the fuel, axial reflectors, axial gamma and neutron shielding, fuel gas plenum, heat removal mechanism and primary heat exchangers, with the metal sheets integrated into a single block.

In one embodiment, the layers are configured from metal sheets that house the fuel, axial reflectors, axial gamma and neutron shielding, fuel gas plenum, heat removal mechanism and primary heat exchangers, with the metal sheets integrated into a single block. Preferably, the layers are respectively formed from a plurality of stacked metal sheets. In one such embodiment, the first layer comprises the nuclear fuel housed in the center with a neutron reflector, a gas plenum, a gamma shield, a neutron shield and a primary heat exchanger off to a side of the nuclear fuel. Desirably, the neutron reflector is supported directly on either side of the fuel, the gas plenum is supported directly on another side of the neutron reflector, the gamma shield is supported directly on another side of the gas plenum, the neutron shield is supported directly on another side of the gamma shield and the primary heat exchanger is supported directly on another side of the neutron shield.

In another embodiment, the plurality of layers includes a third layer comprising a moderator. Preferably, the moderator is a metal hydride such as Yttrium hydride. In still another embodiment, the second layer comprises, as the heat transport system, a plurality of heat pipes. Preferably, the heat pipes are configured from a plurality of etched or machined channels in the second layer along with a wick for transporting a condensed fluid back to an evaporator area, which may be in the middle of the layer. Desirably, the wick includes a melting material that will bond the wick to the channels under diffusion bonding or isostatic pressing of the plurality of layers such as a brazing material comprising nickel. Preferably, the channels are rectangular or circular in cross-section.

In an additional embodiment, the plurality of layers comprise a plurality of modules respectively comprising a stacked integral arrangement of the first layer and the second layer with the modules stacked on top of one another to form a reactor core. The metal sheets that form a layer may comprise steel, stainless steel, molybdenum or a zirconium based alloy. Preferably, the metal sheets are integrated together in a single integral block to allow diffusion bonding or isostatic pressing.

### BRIEF DESCRIPTION OF THE DRAWINGS

A further understanding of the invention can be gained from the following description of the preferred embodiments when read in conjunction with the accompanying drawings in which:

FIG. 1 is a simplified isometric view of a reactor in accordance with one example embodiment of the invention;

FIG. 2 is a simplified isometric view of the reactor of FIG. 1 shown with some external components;

FIG. 3 is a schematic top view of a fuel layer in accordance with one example embodiment of the invention, such as viewed generally along line T of FIG. 1;

FIG. 4 is a schematic top view of a heat transport layer in accordance with one example embodiment of the invention, such as viewed generally along line T of FIG. 1;

FIG. 5 is a schematic top view of a moderator layer in accordance with one example embodiment of the invention, such as viewed generally along line T of FIG. 1;

FIG. 6 is a schematic sectional view of a representative portion of a core section of a reactor, such as taken along line A-A of FIG. 1, in accordance with one example embodiment of the invention;

FIG. 7 is a schematic sectional view of a representative portion of a heat exchanger section of a reactor, such as taken along either of lines B-B or C-C of FIG. 1, in accordance with one example embodiment of the invention;

FIG. 8 is a schematic sectional view of a representative portion of a core section of a reactor, such as taken along line A-A of FIG. 1, in accordance with one example embodiment of the invention; and

FIG. 9 is a schematic sectional view of a representative portion of a heat exchanger section of a reactor, such as taken along either of lines B-B or C-C of FIG. 1, in accordance with one example embodiment of the invention.

### DESCRIPTION OF THE PREFERRED EMBODIMENT

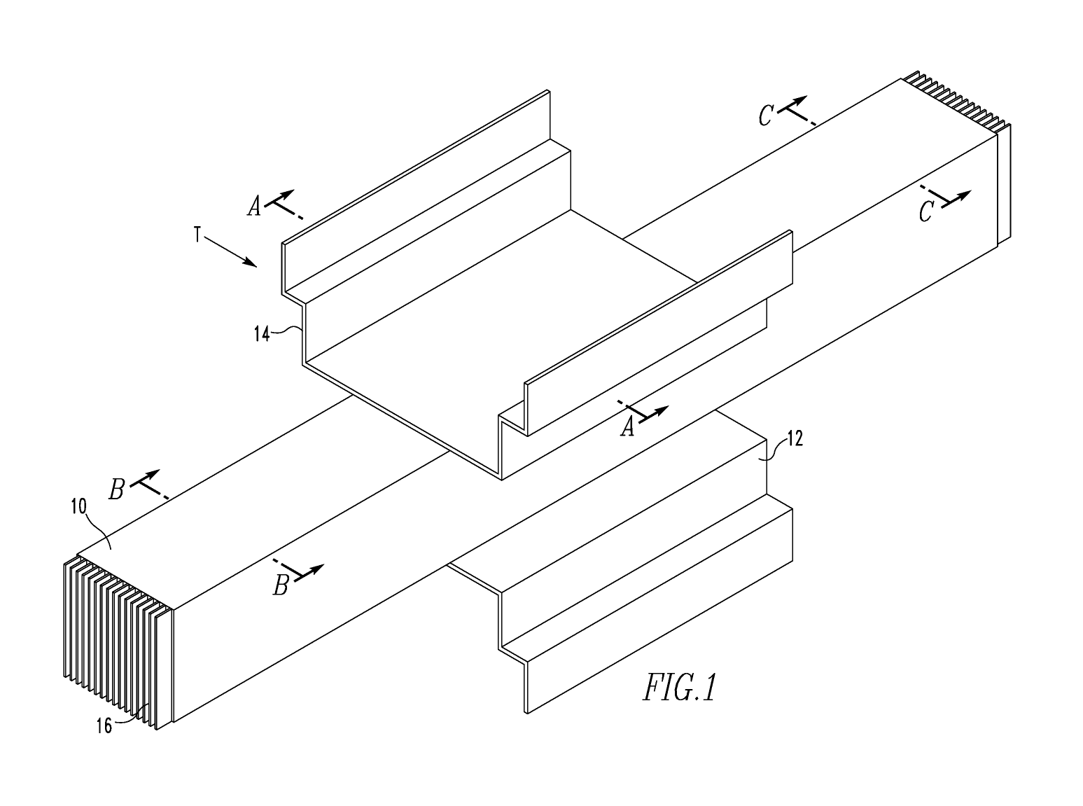

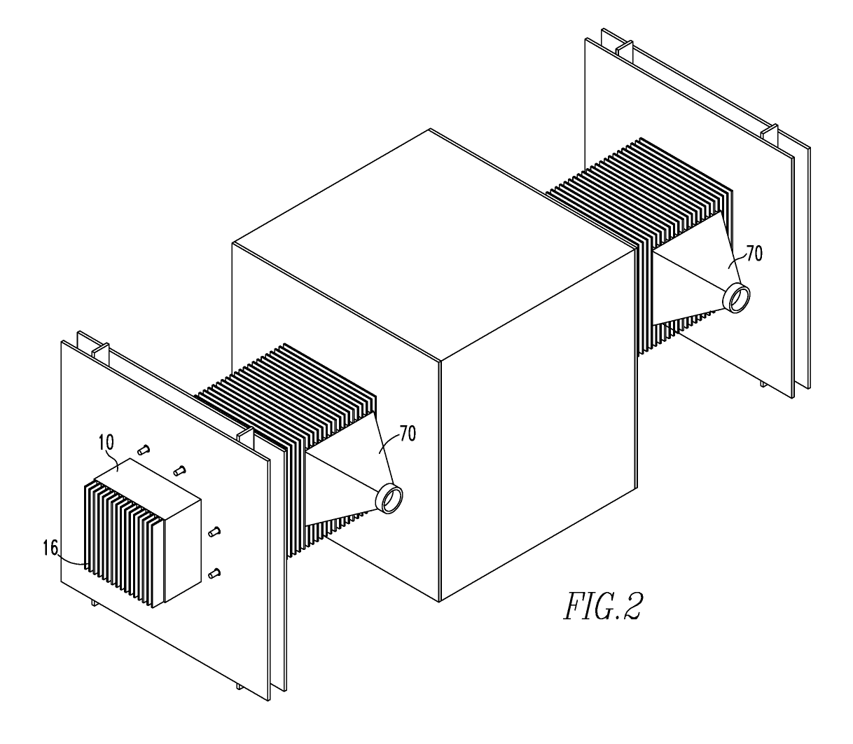

This invention provides a layered approach to combine simple “plate” geometries with the use of diffusion bonding and computer aided manufacturing techniques that integrate all the fuel, axial reflectors, axial gamma and neutron shielding, fuel gas plenum, heat removal mechanism, primary heat exchangers and moderator all in one block 10, such as shown in FIG. 1 along with a lower support structure 12 and an upper support structure 14. The design involves the use of a plurality of metal sheets 16, which can be machined, cut or formed and then stacked in such a way that cavities are formed which are utilized to house the various aforementioned materials to enable proper functioning of the nuclear reactor. In the example shown in FIGS. 1 and 2, the metal sheets 16 are positioned generally vertically (i.e., with one edge disposed generally above or below the opposite edge, it is to be appreciated however that sheets 16 may also be positioned horizontally (i.e., lying flat) or in any other suitable orientation without varying form the scope of the invention.

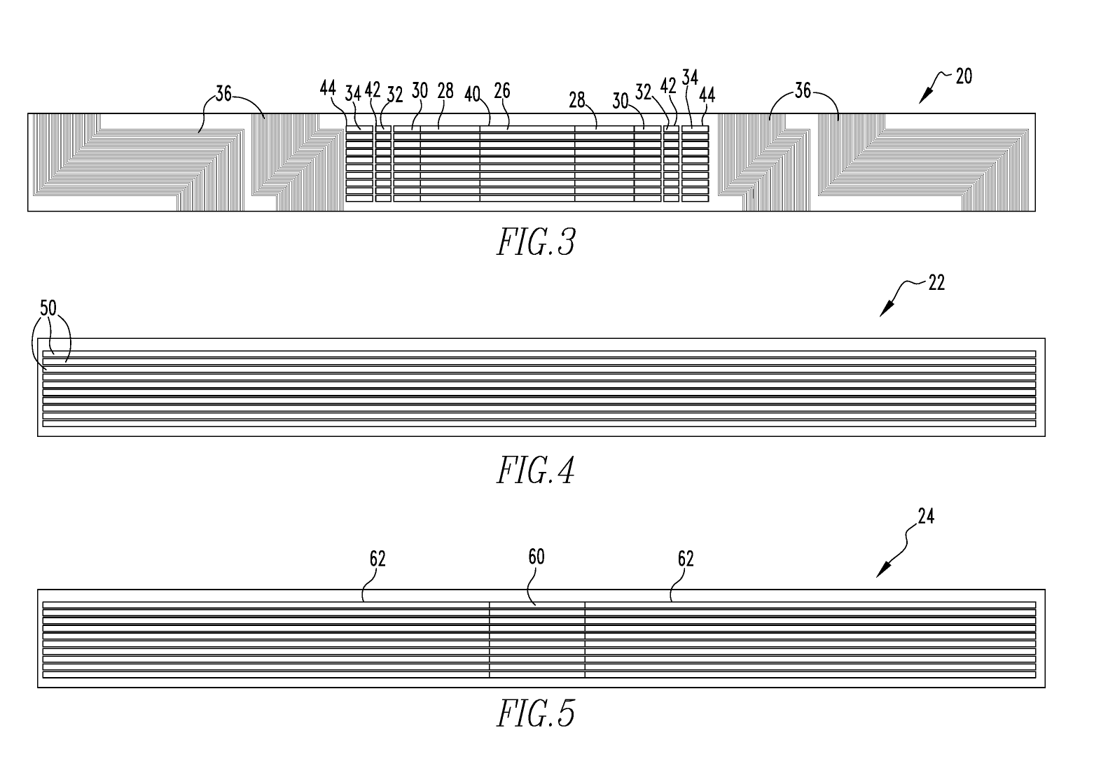

Block 10 is formed from two or three different types of layers depending on the application, which are stacked, typically provided in a repeating pattern such that a single block 10 includes a plurality of each type of layer. One of such layers is a fuel layer 20, a top view of one example of such is provided in FIG. 3, discussed further below. Another of such layers is a heat transport layer 22, a top view of one example of such is provided in FIG. 4, discussed further below. Another of such layers is a moderator layer 24, a top view of one example of such is provided in FIG. 5, discussed further below. The moderator layers are applicable to thermal reactors and can be omitted for a fast reactor design.

Referring to FIG. 3, fuel layer 20 includes nuclear fuel 26 (such as uranium nitride, uranium silicide, uranium dioxide) disposed generally in the center, with a neutron reflector 28 (such as alumina or Beryllium oxide), a gas plenum 30 to house released fission gases, a gamma shield 32 (such as tungsten or tungsten carbide), a neutron shield 34 (such as boron carbide) and a number of embedded micro channels 36 for secondary fluid heat exchange, positioned on one or both sides of nuclear fuel 26. In the example shown in FIG. 3, the nuclear fuel 26, neutron reflector 28 and gas plenum 30 are provided together in a single cavity 40 (a duplicative number of which are illustrated) whereas gamma shield 32 and neutron shield 34 are each provided in separate cavities 42 and 44 (a duplicative number of which are illustrated) arranged in a row 46 on both ends of cavity 40. It is to be appreciated, however, that one or both of gamma shield 32 and neutron shield 34 may be included in cavity 40, or gamma shield 32 and neutron shield 34 may be combined together in a single cavity separate from cavity 40, without varying from the scope of the invention. It is also to be appreciated that although ten rows 46 of the aforementioned arrangements are illustrated in FIG. 3, one or more of the quantity and/or relative sizing of such rows 46 may be varied without varying from the scope of the invention.

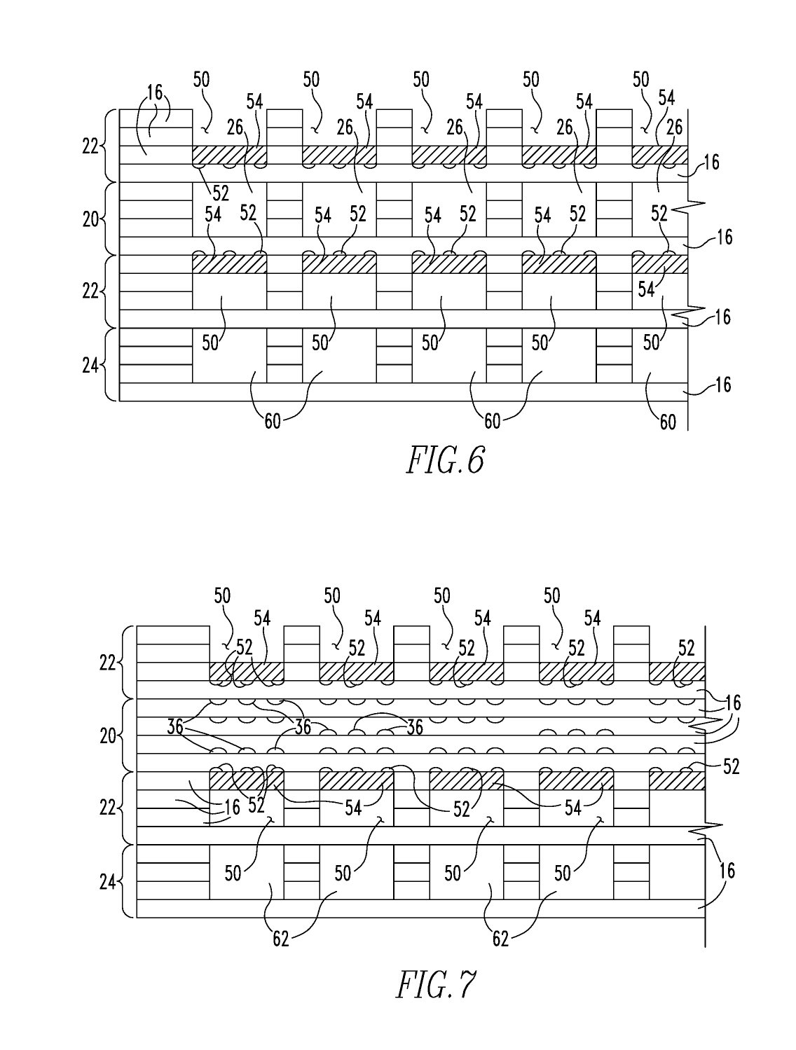

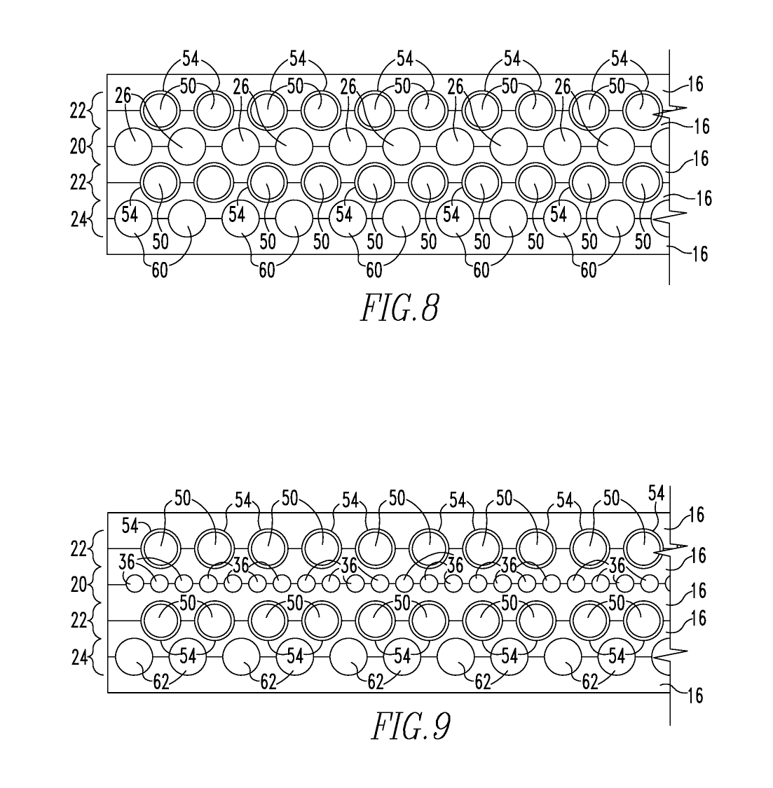

Referring to FIG. 4, heat transport layer 22 utilizes the principle of heat pipes to passively transport heat from the core (central region of block 10) to the heat exchangers (on either ends of the block) formed generally by micro channels 36 (FIG. 3). Accordingly, heat transport layer 22 may include machined and/or etched channels 50, 52 along with a wick 54 to transport condensed fluid back to the middle of the core. While a double heat pipe that transports heat from the center to either end is shown in the figures, a single heat pipe can be used when heat is to be transported to only one end. To enable the bonding of the wick 54 to the adjacent metal plate 16, a brazing material, such as low melting nickel alloy can be used. FIGS. 6 and 7 show an example embodiment which utilizes rectangular channels while FIGS. 8 and 9 show an example embodiment which utilizes circular channels. Apart from heat pipes, the concept is also applicable to a pumped flow type nuclear reactor, where the heat pipe channels can be substituted for channels for the pumped primary coolant, such as lead, sodium, molten salt or high temperature gas.

Referring to FIG. 5, moderator layer 24 houses a moderator 60 such as a metal hydride (e.g., Yttrium hydride). The moderator layer 24 is comprised of sheet metal plate that has similar dimensions to that of the fuel plate dimensions. The rest of the channels 62 are voids to allow hydrogen to leave the core during accident scenarios when overheating of the core releases the moderating hydrogen out of the core region. A palladium membrane selective plug may be provided at the ends of channels 62 to release hydrogen out of the block without over pressurizing it; however, such arrangement allows other gases that may have evolved via fission to be retained within the block 10.

Block 10 may comprise repeating module units of four layers (moderator-heat pipe-fuel-heat pipe) or 3 layers (moderator-fuel-heat pipe) that can be stacked to make a core of any size and shape and be integrated with primary and decay heat exchangers. Alternatively, block 10 may comprise similar arrangements but without a moderator layer. The metal plates 16 can be steel, stainless steel or molybdenum based metals for fast, epithermal and thermal neutron spectrum operation, while zirconium based alloys may be more suitable for a thermal and epithermal neutron spectrum.

FIGS. 6-9 show cross sectional areas of repeated units of example integrated nuclear reactors of this invention. Two embodiments are shown with FIGS. 6 and 7 showing a rectangular design and FIGS. 8 and 9 showing circular or elliptical channels. The four layers shown in FIGS. 6-9 are stacked based on the neutronic and thermal-structural design of the nuclear reactor. The bottom layer needs to be repeated on top of the last stack to ensure stacking symmetry (to prevent out of plane deformation after diffusion bonding). The layers are then diffusion bonded or bonded via hot isostatic pressing to merge the grain boundaries of all the individual layers into each other, thus forming a single block with integrated fuel, heat pipes, reflectors, shields and heat exchangers.

FIGS. 8 and 9 show an embodiment of the invention where metallic plates 16 having channels made by chemical etching, machining, forming or extrusions are inverted to make cylindrical or elliptical channels, which can enable pellet type cylindrical fuels, elliptical heat pipes and elliptical channels for all gas spaces. Having cylindrical or elliptical channels has inherent advantages in reducing stress, and improving the fuel, heat pipe or moderator density, compared to rectangular channels.

Once block 10 is formed, the heat pipes can be loaded with the primary heat transfer fluid and seal the fluid loading junctions at the ends of the heat pipe. Nozzles 70 (see FIG. 1) can be welded onto the inlets and the outlets of the block to complete the primary heat exchangers. Radial reflectors and shield can be integrated to complete the reactor. Control drums and/or control rods can be integrated into the reflectors for a small core or in between blocks for a larger reactor.

From the foregoing it is thus to be appreciated that this invention provides a nuclear reactor with the fuel, neutron reflector, fission gas plenum, gamma shield, neutron shield, decay heat exchanger and primary heat exchanger and heat pipes all integrated in one block, without the need for welding or other manual and time intensive joining process. The wicks of the heat pipes are bonded to the adjacent metal sheets during the diffusion bonding process by the use of a lower melting metal/alloy such as nickel brazing materials. No additional mandrel is necessary. In other words, the wicks can be pre-manufactured and integrated into the block during the assembly process. The plate design enables the use of composite wicks, which includes both wick body and grooves to enable higher heat flux. The grooves can be machined, formed, laser etched or chemically etched. The layered approach enables automation of the manufacturing process, such as by laser cutting, CNC machining, forming processes and plate stacking and handling automated processes. This enables automated fabrication of nuclear reactors, which has never been done before in the history of the nuclear industry. Automated fabrication enables an integrated computer aided design and manufacturing of the nuclear reactor. The layered approach also enables the automated parametric scalability of the reactor in terms of size and power conversion. This invention is applicable to any reactor design. Instead of heat pipes, there are channels for primary coolant flow paths, which can take heat from the center region (housing the fuel) to the ends of the block where it can be transferred to the primary heat exchanger channels. For a pumped fluid, the inlet and outlet nozzles can be on the ends of the block, while primary and decay heat exchanger nozzles are on the side of the block, perpendicular to the length of the monolithic block.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear reactor system formed as an integral block in a plurality of layers, the plurality of layers comprising:
a first layer comprising:
a nuclear fuel,
a neutron reflector,
a gas plenum,
a gamma shield, and
a neutron shield; and
a second layer comprising a heat transport system.

2. The nuclear reactor system of claim 1, wherein each of the first layer and the second layer are formed from a plurality of stacked metal sheets.

3. The nuclear reactor system of claim 1, wherein the first layer has the nuclear fuel housed in the center with the neutron reflector, the gas plenum, the gamma shield, the neutron shield and a primary heat exchanger off to a side of the nuclear fuel.

4. The nuclear reactor system of claim 3, wherein the neutron reflector, the gas plenum, the gamma shield, the neutron shield and the primary heat exchanger are situated on both sides of the nuclear fuel.

5. The nuclear reactor system of claim 1, including a third layer comprising a moderator.

6. The nuclear reactor system of claim 5, wherein the moderator is a metal hydride.

7. The nuclear reactor system of claim 6, wherein the metal hydride is Yttrium hydride.

8. The nuclear reactor system of claim 1, wherein the second layer comprises a plurality of heat pipes.

9. The nuclear reactor system of claim 8, wherein the heat pipes are configured from a plurality of etched or machined channels in the second layer along with a wick for transporting a condensed fluid back to an evaporator area above or below the fuel.

10. The nuclear reactor system of claim 9, wherein the wick comprises a low melting material that will bond the wick to the adjacent metal sheets under diffusion bonding of the plurality of layers.

11. The nuclear reactor system of claim 10, wherein the low melting material is a brazing material comprising nickel.

12. The nuclear reactor system of claim 9, wherein the channels have a substantially rectangular or circular cross-section.

13. The nuclear reactor system of claim 1, wherein the plurality of layers comprises a plurality of modules respectively comprising a stacked integral arrangement of the first layer and the second layer with the modules stacked on top of one another to form a reactor core.

14. The nuclear reactor system of claim 1, wherein the metal sheets comprise steel, stainless steel, molybdenum or a zirconium based alloy.

15. The nuclear reactor system of claim 1, wherein the metal sheets are integrated together in a single integral block by diffusion bonding or isostatic pressing.
